(19) United States
(12) Patent Application Publication
(10) Pub. No.: US 2024/0081407 A1
(43) Pub. Date: Mar. 14, 2024

(54) ATOMIZER, ELECTRONIC ATOMIZATION DEVICE AND ATOMIZATION ASSEMBLY

(71) Applicant: SHENZHEN FIRST UNION TECHNOLOGY CO., LTD., Shenzhen, Guangdong Province (CN)

(72) Inventors: Yuelong FU, Shenzhen, Guangdong Province (CN); Zhongli XU, Shenzhen, Guangdong Province (CN); Yonghai LI, Shenzhen, Guangdong Province (CN)

(73) Assignee: SHENZHEN FIRST UNION TECHNOLOGY CO., LTD., Shenzhen, Guangdong Province (CN)

(21) Appl. No.: 18/263,909

(22) PCT Filed: Jan. 24, 2022
(86) PCT No.: PCT/CN2022/073541

§ 371 Date: Aug. 2, 2023

(30) Foreign Application Priority Data
Feb. 5, 2021 (CN) 202110163395.7

(51) Int. Cl. A24F 40/46; A24F 40/10; A24F 40/44; H05B 3/26

(52) U.S. Cl. CPC A24F 40/46; A24F 40/10; A24F 40/44; H05B 3/265; H05B 2203/021

(57) ABSTRACT

A vaporizer includes: a liquid storage cavity; a porous body, being in fluid communication with the liquid storage cavity to absorb the liquid substrate, and having a vaporization surface; and a resistance heating trajectory, formed on the vaporization surface and configured to heat at least a part of the liquid substrate of the porous body to generate an aerosol, where the vaporization surface is a flat plane, and includes a length direction and a width direction perpendicular to the length direction; the resistance heating trajectory includes a first end and a second end, and extends between the first end and the second end in a zigzag way in the length direction of the vaporization surface; and a distance that the first end and the second end span in the vaporization surface in the length direction is greater than 75% of a length dimension of the vaporization surface.

### CROSS-REFERENCE TO RELATED APPLICATIONS

This application claims priority to Chinese Patent Application No. 2021101633957, entitled “VAPORIZER, ELECTRONIC VAPORIZATION APPARATUS, AND VAPORIZATION ASSEMBLY” filed on the China National Intellectual Property Administration on Feb. 5, 2021, which is incorporated herein by reference in its entirety.

### TECHNICAL FIELD

Embodiments of this application relate to the technical field of electronic vaporization apparatuses, and in particular, to a vaporizer, an electronic vaporization apparatus, and a vaporization assembly.

### BACKGROUND

Tobacco products (such as cigarettes and cigars) burn tobacco during use to produce tobacco smoke. Attempts are made to replace these tobacco-burning products by manufacturing products that release compounds without burning tobacco.

An example of such products is a heating apparatus that releases compounds by heating rather than burning materials. For example, the materials may be tobacco or other non-tobacco products, where the non-tobacco products may or may not include nicotine. As another example, there are aerosol-providing products, for example, electronic vaporization apparatuses. These apparatuses usually contain a liquid substrate, and the liquid substrate is heated to vaporize, so as to generate an inhalable vapor or an aerosol. The liquid substrate may contain nicotine, and/or aromatics, and/or aerosol-generation substances (for example, the solvent usually includes propylene glycol and vegetable glycerin). Usually, to increase the amount of the generated aerosol to form larger smoke, the proportion of the vegetable glycerin in the liquid substrate can be increased, but the increase of the viscosity of the liquid substrate is not conducive to infiltration, absorption and transmission by a vaporization assembly.

### SUMMARY

An embodiment of this application provides a vaporizer, configured to vaporize a liquid substrate to generate an aerosol for inhaling, and including:
a liquid storage cavity, configured to store the liquid substrate;
a porous body, being in fluid communication with the liquid storage cavity to absorb the liquid substrate, and having a vaporization surface;
a resistance heating trajectory, formed on the vaporization surface and configured to heat at least a part of the liquid substrate of the porous body to generate an aerosol,
where the vaporization surface is a flat plane, and includes a length direction and a width direction perpendicular to the length direction; the resistance heating trajectory includes a first end and a second end that are opposite to each other in the length direction of the vaporization surface; and a distance between a straight line passing through the first end in the width direction and a straight line passing through the second end in the width direction in the vaporization is surface greater than 75% of a length dimension of the vaporization surface.

The resistance heating trajectory is further lengthened, so that a heat radiation range can be extended to a farther part in the porous body, a high-viscosity liquid substrate away from the vaporization surface can be preheated to reduce the viscosity, and the fluidity of the liquid substrate can be improved.

In a preferred implementation, the porous body has a heat conductivity of 1 to 50 W/(m·K).

In a preferred implementation, the porous body includes a porous ceramic body, where the porous ceramic body includes at least one of silicon carbide, aluminum nitride, boron nitride or silicon nitride.

In a preferred implementation, the projection area of the resistance heating trajectory in the vaporization surface is greater than 35% of the area of the vaporization surface.

In a preferred implementation, the resistance heating trajectory at least partially extends in the width direction of the vaporization surface to a position with a shortest distance from an edge of the vaporization surface less than 0.32 mm.

In a preferred implementation, the resistance heating trajectory includes a first trajectory part and a second trajectory part which are alternately arranged in the length direction of the vaporization surface, where the first trajectory part and/or the second trajectory part are/is curved and have/has different bending directions.

In a preferred implementation, the vaporization surface includes a first side part and a second side part which are opposite to each other in the width direction, where
the first trajectory part is close to the first side part, and the second trajectory part is close to the second side part.

In a preferred implementation, the first trajectory part and/or the second trajectory part are/is configured to bend outwards in the width direction of the vaporization surface.

In a preferred implementation, the first trajectory part and/or the second trajectory part are/is arc-shaped.

In a preferred implementation, the resistance heating trajectory further includes a third trajectory part extending between the adjacent first trajectory part and second trajectory part; and the third trajectory part is straight.

In a preferred implementation, the third trajectory part is arranged obliquely relative to the width direction of the vaporization surface.

In a preferred implementation, the curvature of any position of the first trajectory part and/or the second trajectory part is not zero.

In a preferred implementation, the resistance heating trajectory is constructed such that the whole trajectory only includes limited points with the curvature being zero.

In a preferred implementation, the porous body has a liquid channel penetrating through the porous body in a length direction, and is in fluid communication with the liquid storage cavity through the liquid channel to absorb the liquid substrate of the liquid storage cavity.

In a preferred implementation, the liquid channel has an inner bottom wall close to and parallel with the vaporization surface, and a distance between the inner bottom wall and the vaporization surface is less than 1.5 mm.

In a preferred implementation, the vaporizer further includes:
a liquid guide channel, positioned between the liquid storage cavity and the porous body, and providing a fluid path for the liquid substrate of the liquid storage cavity to flow to the liquid channel,
where the porous body is configured without a part positioned between the liquid guide channel and the liquid channel.

In a preferred implementation, the porous body includes a first side wall and a second side wall which are arranged oppositely in the width direction of the vaporization surface, and a base part positioned between the first side wall and the second side wall, and the liquid channel is defined jointly by the first side wall, the second side wall and the base part; and
a groove extending in an axial direction of the porous body is formed in a surface, adjacent to the liquid channel, of the base part, and is configured to increase the surface area of the base part for absorbing the liquid substrate.

Another embodiment of this application further provides a vaporizer, configured to vaporize a liquid substrate to generate an aerosol for inhaling, and including:
a liquid storage cavity, configured to store a liquid substrate;
a porous body, being in fluid communication with the liquid storage cavity to absorb the liquid substrate, and having a vaporization surface, where the porous body defines a liquid channel that is basically parallel with the vaporization surface and penetrates through the porous body; and
a resistance heating trajectory, formed on the vaporization surface and configured to heat at least a part of the liquid substrate of the porous body to generate an aerosol,
where an end part of the liquid channel is defined as an avoidance part by at least one step surface, and where an end part of the liquid channel is defined as an avoidance part by at least one step surface, and a distance between an inner wall of the liquid channel and the vaporization surface is less than a shortest distance between the step surface and the vaporization surface.

Another embodiment of this application further provides an electronic vaporization apparatus, including a vaporizer configured to vaporize a liquid substrate to generate an aerosol for inhaling, and a power supply assembly supplying power to the vaporizer, where the vaporizer includes the vaporizer described above.

Yet another embodiment of this application further provides a vaporization assembly for an electronic vaporization apparatus, including a porous body for absorbing a liquid substrate, where the porous body has a vaporization surface, and a resistance heating trajectory is formed on the vaporization surface; the vaporization surface is a flat plane, and includes a length direction and a width direction perpendicular to the length direction; the resistance heating trajectory includes a first end and a second end that are opposite to each other in the length direction of the vaporization surface; and a distance between a straight line passing through the first end in the width direction and a straight line passing through the second end in the width direction in the vaporization surface is greater than 75% of a length dimension of the vaporization surface.

### BRIEF DESCRIPTION OF THE DRAWINGS

The objective implementation, functional features and advantages of this application are further illustrated in combination with embodiments and with reference to the accompanying drawings. One or more embodiments are exemplarily described with reference to the corresponding figures in the accompanying drawings, and the descriptions are not to be construed as limiting the embodiments. Elements in the accompanying drawings that have the same reference numerals are represented as similar elements, and unless otherwise particularly stated, the figures in the accompanying drawings are not drawn to scale.

FIG. 1 is a schematic diagram of an electronic vaporization apparatus according to an embodiment of this application;

FIG. 2 is a schematic structural diagram of a vaporizer in FIG. 1 from one perspective;

FIG. 3 is a schematic cross-sectional view in a longitudinal direction of a vaporizer in FIG. 2;

FIG. 4 is a schematic structural diagram of a vaporization assembly in FIG. 3 from one perspective;

FIG. 5 is a schematic structural diagram of a vaporization assembly in FIG. 4 from another perspective;

FIG. 6 is a schematic diagram of a vaporization surface of a vaporization assembly in FIG. 5 from a positive projection perspective;

FIG. 7 is a schematic structural diagram of a resistance heating trajectory according to another embodiment;

FIG. 8 is a schematic diagram of a vaporization assembly in FIG. 4 from a side perspective in a length direction;

FIG. 9 is a schematic diagram of a vaporization assembly according to another embodiment from a positive projection perspective in a length direction;

FIG. 10 is a schematic diagram of a vaporization assembly in FIG. 4 from a side perspective in a width direction;

FIG. 11 is a curve of a viscosity of a liquid substrate according to one embodiment varying along with a temperature;

FIG. 12 is a schematic diagram of a thermal field of a vaporization surface in FIG. 4 in heating simulation of a vaporization assembly;

FIG. 13 is a schematic diagram of a thermal field in heating simulation of a vaporization assembly in FIG. 4 from a sectional perspective;

FIG. 14 is a schematic diagram of a thermal field in heating simulation of a vaporization assembly in FIG. 4 from another sectional perspective;

FIG. 15 is a schematic diagram of flow velocity distribution of a liquid substrate of a vaporization surface in FIG. 4 in heating simulation of a vaporization assembly;

FIG. 16 is a schematic diagram of flow velocity distribution of a liquid substrate in heating simulation of a vaporization assembly in FIG. 4 from one section perspective;

FIG. 17 is a schematic diagram of flow velocity distribution of a liquid substrate in heating simulation of a vaporization assembly in FIG. 4 from another section perspective;

FIG. 18 is a schematic diagram of flow velocity distribution of a liquid substrate of a vaporization surface in heating simulation of a vaporization assembly according to a contrast example;

FIG. 19 is a schematic diagram of flow velocity distribution of a liquid substrate in heating simulation of a vaporization assembly according to a comparative example from one sectional perspective;

FIG. 20 is a schematic diagram of flow velocity distribution of a liquid substrate in heating simulation of a vaporization assembly according to a comparative example from another section perspective; and

FIG. 21 is a schematic structural diagram of a porous body according to yet another embodiment.

### DETAILED DESCRIPTION

It is to be understood that the specific embodiments described herein are merely used to explain this application but are not intended to limit this application. For ease of understanding of this application, this application is described below in more detail with reference to the accompanying drawings and specific implementations. When an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as that usually understood by a person skilled in the art to which this application belongs. The terms used in this specification of this application are merely intended to describe objectives of the specific implementations, and are not intended to limit this application. A term “and/or” used in this specification includes any or all combinations of one or more related listed items.

For ease of understanding of this application, this application is described below in more detail with reference to the accompanying drawings and specific implementations.

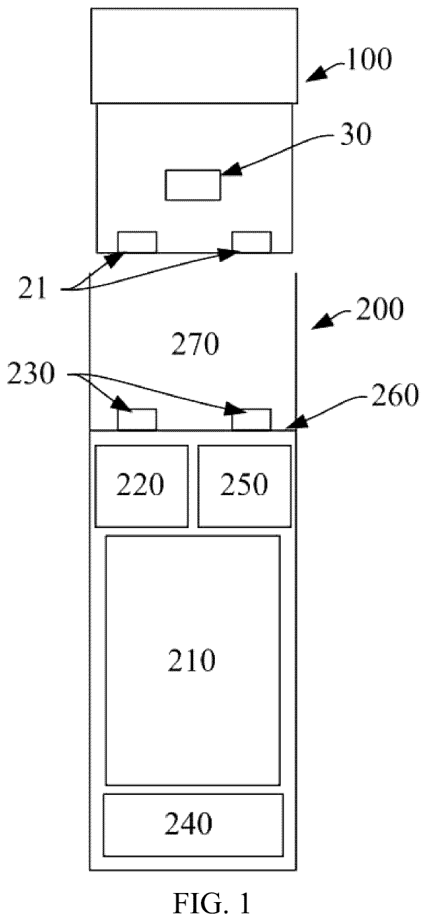

This application provides an electronic vaporization apparatus. Referring to FIG. 1, the electronic vaporization apparatus includes: a vaporizer 100, configured to store a liquid substrate and vaporize the liquid substrate to generate an aerosol; and a power supply mechanism 200, configured to supply power to the vaporizer 100.

In an optional implementation, as shown in FIG. 1, the power supply mechanism 200 includes: a receiving cavity 270, arranged at one end in a length direction and configured to receive and accommodate at least a part of the vaporizer 100; and a first electrical contact 230, at least partially exposed on a surface of the receiving cavity 270 and configured to be electrically connected to the vaporizer 100 to supply power to the vaporizer 100 when at least a part of the vaporizer 100 is received and accommodated in the power supply mechanism 200.

According to a preferred implementation shown in FIG. 1, a second electrical contact 21 is arranged at an end part of the vaporizer 100 opposite to the power supply mechanism 200 in the length direction, so that when the at least a part of the vaporizer 100 is received in the receiving cavity 270, the second electrical contact 21 is in contact with and abuts against the first electrical contact 230 to conduct electricity.

A sealing member 260 is arranged in the power supply mechanism 200, and at least a part of an internal space of the power supply mechanism 200 is separated by the sealing member 260 to form the above receiving cavity 270. In the preferred implementation shown in FIG. 1, the sealing member 260 is constructed to extend in a cross-sectional direction of the power supply mechanism 200, and is prepared by a flexible material, so as to prevent the liquid substrate seeping from the vaporizer 100 to the receiving cavity 270 from flowing to a controller 220, a sensor 250, and other components in the power supply mechanism 200.

In the preferred implementation shown in FIG. 1, the power supply mechanism 200 further includes a core 210, located close to the other end opposite to the receiving cavity 270 in the length direction, and configured to supply power; and the controller 220, arranged between the core 210 and an accommodating cavity, and operably guiding a current between the core 210 and the first electrical contact 230.

During use, the power supply mechanism 200 includes the sensor 250, configured to sense an inhalation flow generated by using a suction nozzle cover 20 of the vaporizer 100 during inhalation, so that the controller 220 controls the core 210 to output a current to the vaporizer 100 according to a detection signal of the sensor 250.

Further, in the preferred implementation shown in FIG. 1, a charging interface 240 is arranged at the other end, away from the receiving cavity 270, of the power supply mechanism 200, and is configured to supply power to the core 210 after being connected to an external charging device.

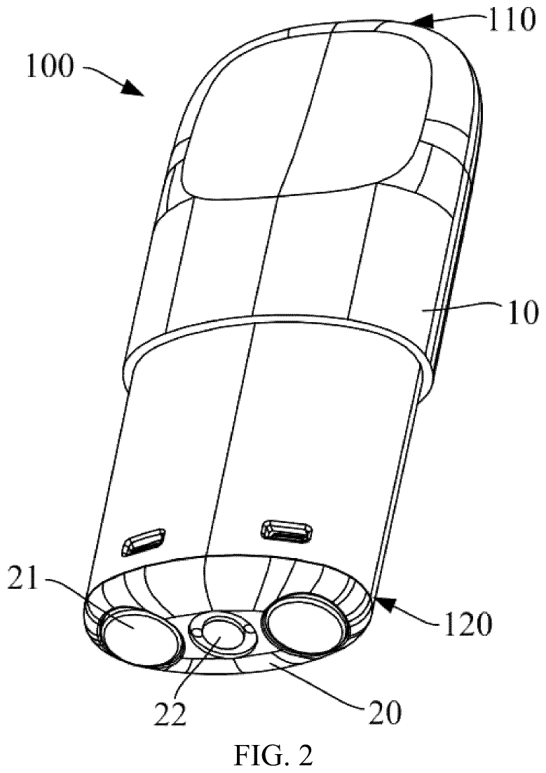

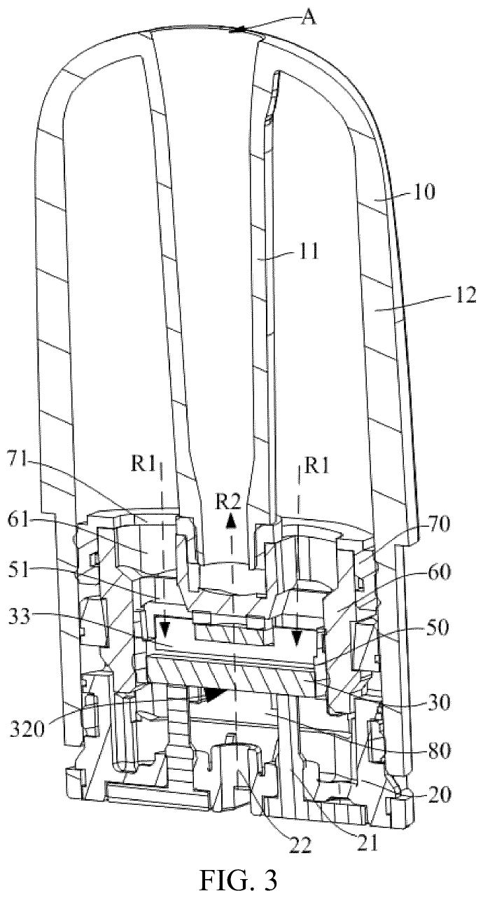

FIG. 2 and FIG. 3 are specific schematic structural diagrams of a vaporizer 100 according to an embodiment of this application. In this embodiment, the vaporizer includes: a main housing 10. As shown in FIG. 2 and FIG. 3, the main housing 10 is substantially in a flat cylindrical shape, and certainly, a hollow interior of the main housing is a necessary functional device configured to store and vaporize the liquid substrate. The main housing 10 has a near end 110 and a far end 120 opposite to each other in the length direction. According to requirements for common use, the near end 110 is configured as an end for a user to inhale the aerosol, and a suction nozzle A for the user to suck is arranged at the near end 110; and the far end 120 is used as an end combined with the power supply assembly 200, and the far end 120 of the main housing 10 is an opening on which a detachable end cap 20 is mounted. The opening structure is configured to mount necessary functional components inside the main housing 10.

Further, in the implementation shown in FIG. 2, the second electrical contact 21 for conducting with the first electrical contact 230 of the power supply assembly 200 is arranged on the end cap 20.

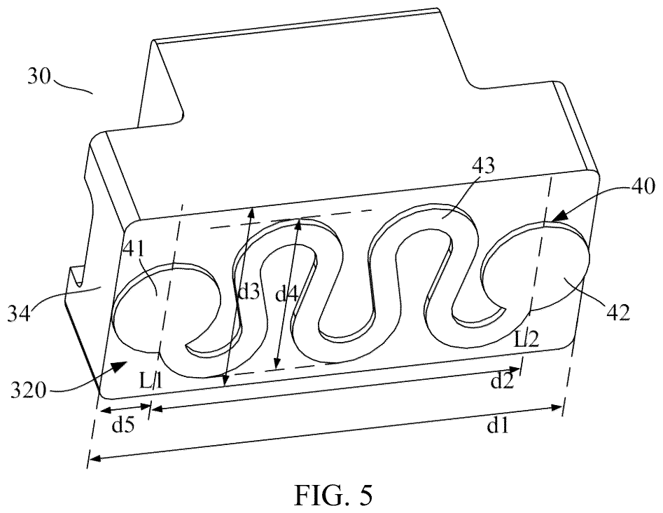

Further referring to, FIG. 2, FIG. 3 and FIG. 5, the main housing 10 is internally provided with a liquid storage cavity 12 for storing the liquid substrate, and a vaporization assembly for absorbing the liquid substrate from the liquid storage cavity 12, and heating and vaporizing the liquid substrate. In FIG. 3 and a usual implementation, the vaporization assembly includes a liquid guide element such as a porous body 30 in FIG. 3, and a heating element 40 configured to heat and vaporize a liquid substrate absorbed by the porous body 30. Specifically, in the schematic diagram of the sectional structure shown in FIG. 3, the porous body 30 has one side which is close to the liquid storage cavity 12 in a longitudinal direction of the main housing 10 and is in fluid communication with the liquid storage cavity to absorb the liquid substrate; and the porous body 30 further has a vaporization surface 320 away from the liquid storage cavity 12 in the longitudinal direction of the main housing 10, and the vaporization surface 320 is provided with a heating element 40 for heating at least a part of the liquid substrate in the porous body 30 to generate an aerosol and release the aerosol in a vaporization chamber 80 defined between the vaporization surface 320 and the end cap 20.

Further, a vapor-gas transmission pipe 11 arranged in an axial direction is arranged inside the main housing 10, and the liquid storage cavity 12 configured to store the liquid substrate is formed in a space between an outer wall of the vapor-gas transmission pipe 11 and an inner wall of the main housing 10. A first end of the vapor-gas transmission pipe 11 opposite to the near end 110 is in communication with the suction nozzle A, and a second end opposite to the far end 120 is in airflow connection with a vaporization chamber 80 that releases the aerosol, thereby transmitting the aerosol generated by vaporizing the liquid substrate by the heating element 40 and released to the vaporization chamber 80 to the suction nozzle A for inhalation.

Further referring to FIG. 3, in order to assist in the installation and fixation of the porous body 30 and the sealing of the liquid storage cavity 12, the main housing 10 is further internally provided with a flexible silicone sleeve 50, a rigid support frame 60 and a flexible first seal element 70, thereby not only sealing an opening of the liquid storage cavity 12, but also fixing and holding the porous body 30 inside.

In terms of a specific structure and shape, the flexible silicone sleeve 50 is substantially hollow and cylindrical, is hollow inside for accommodating the porous body 30, and is sleeved outside the porous body 30 through tight fit.

The rigid support frame 60 holds the porous body 30 sleeved with the flexible silicone sleeve 50. In some embodiments, the rigid support frame may be substantially in a ring shape with a lower end being an opening, and an inner space thereof is configured to accommodate and hold the flexible silicone sleeve 50 and the porous body 30. On one hand, the flexible silicone sleeve 50 can seal a gap between the porous body 30 and the support frame 60 to prevent the liquid substrate from seeping out of the gap between the porous body 30 and the support frame 60. On the other hand, the flexible silicone sleeve 50 is located between the porous body 30 and the support frame 60, which is advantageous for the porous body 30 to be stably accommodated in the support frame 60 to avoid loosening.

The flexible seal element 70 is arranged on an end portion of the liquid storage cavity 12 facing the far end 120, and a shape thereof matches a cross section of an inner contour of the main housing 10, thereby sealing the liquid storage cavity 12 and preventing the liquid substrate from seeping from the liquid storage cavity 12. Further, to prevent shrinkage and deformation of a flexible seal element 70 made of a flexible material from affecting sealing tightness, the above rigid support frame 60 is accommodated in the flexible seal element 70 to support the flexible seal element.

After mounting, to ensure smooth transmission of the liquid substrate and output of the aerosol, a first liquid guide hole 71 for the liquid substrate to flow through is formed in the flexible seal element 70, a second liquid guide hole 61 is correspondingly arranged on the rigid support frame 60, and a third liquid guide hole 51 is formed in the flexible silicone sleeve 50. During use, the liquid substrate in the liquid storage cavity 12 sequentially passes through the first liquid guide hole 71, the second liquid guide hole 61 and the third liquid guide hole 51 and flows to the liquid channel 33 of the porous body 30 held in the flexible silicone sleeve 50, and then is absorbed by the porous body 30. As shown in an arrow R1 in FIG. 3, the liquid substrate is absorbed and conveyed to the vaporization surface 320 for vaporization, and then the generated aerosol is released into the vaporization chamber 80 defined between the vaporization surface 320 and the end cap 20.

Certainly, as shown in FIG. 2 and FIG. 3, the end cap 20 is further provided with an air inlet 23. An airflow during inhalation is shown in an arrow R2 in FIG. 3. The air enters the vaporization chamber 80 through the air inlet 23, and then carries the generated aerosol to be outputted to vapor-gas transmission pipe 11 until being inhaled at the suction nozzle A.

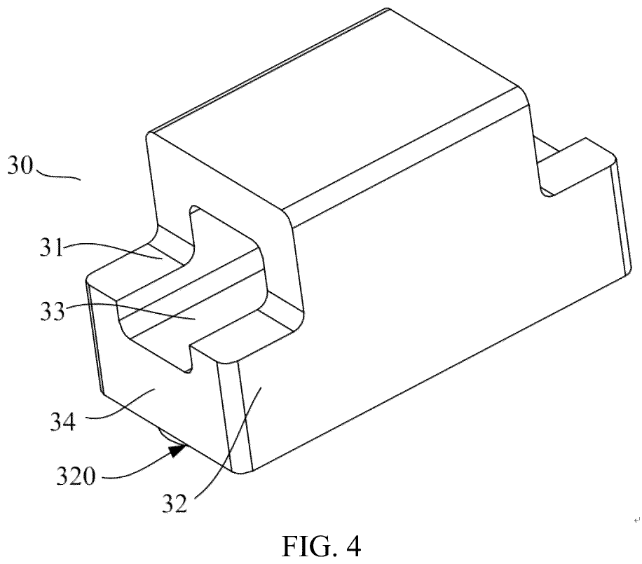

Referring to the structure of the porous body 30 shown in FIG. 3, FIG. 4 and FIG. 5, the shape of the porous body 30 is constructed to be, but not limited to, generally a blocky structure in the embodiment. According to the preferred design of this embodiment, the porous body includes a first side wall 31 and a second side wall 32 which are arched and are opposite to each other in a thickness direction, and a base part 34 extending between the first side wall 31 and the second side wall 32; and a lower surface of the base part 34 is respectively configured as a vaporization surface 320. In addition, the first side wall 31 and the second side wall 32 extend in a width direction to define a liquid channel 33 between the first side wall 31 and the second side wall 32, and two ends of the liquid channel 33 are in fluid communication with the liquid storage cavity 12 so as to receive the liquid substrate.

In some implementations, the porous body 30 may be made of a material of a hard capillary structure, such as a porous ceramic, a porous glass ceramic and a porous glass. The heating element 40 is preferably formed on the vaporization surface 320 by mixing conductive raw material powder with a printing assistant to form a slurry and then sintering after printing, so that an entire surface or most of the surface of the heating element is closely attached to the vaporization surface 320, and the heating element has the effects such as high vaporization efficiency, less heat loss, and dry-burn prevention or dry-burn reduction. Alternatively, in other variable implementations, the heating element 40 is obtained by bonding a sheet-like or net-like resistive base material on the vaporization surface 320. Certainly, in some embodiments, the heating element 40 may be made of a material such as stainless steel, nickel chromium alloy, iron chromium aluminum alloy and metal titanium.

Further referring to FIG. 5, the heating element 40 includes a first electrode connection portion 41 close to one side of the vaporization surface 320 in the length direction, and a second electrode connection portion 42 close to the other side of the vaporization surface 320 in the length direction; and during use, the first electrode connection portion 41 and the second electrode connection portion 42 are electrically connected in an abutting or welding manner of the positive/negative electrode 21 in FIG. 1, so as to supply power to the heating element 40.

In a preferred implementation in FIG. 5, the first electrode connection portion 41 and the second electrode connection portion 42 are constructed as a circular shape, or in other optional implementation, the first electrode connection portion and the second electrode connection portion may be square or oval. The first electrode connection portion 41 and the second electrode connection portion 42 are preferably made of a material with high resistance coefficient and high conductivity, such as gold and silver.

In a preferred implementation shown in FIG. 5, the first electrode connection portion 41 and the second electrode connection portion 42 are located at a center position in the width direction of the vaporization surface 320. Alternatively, in other optional implementations, the first electrode connection portion 41 and the second electrode connection portion 42 are staggered in the width direction of the vaporization surface 320. For example, the first electrode connection portion 41 is close to a lower side end in the width direction of the vaporization surface 320, and the second electrode connection portion 42 is close to an upper side end in the width direction of the vaporization surface 320.

The heating element 40 further includes a resistance heating trajectory 43 extending between the first electrode connection portion 41 and the second electrode connection portion 42. The resistance heating trajectory 43 is usually made of a resistive metal material and a metal alloy material with a suitable impedance based on the functional requirements of heating and vaporization. For example, a suitable metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-manganese-aluminum based alloy, or stainless steel.

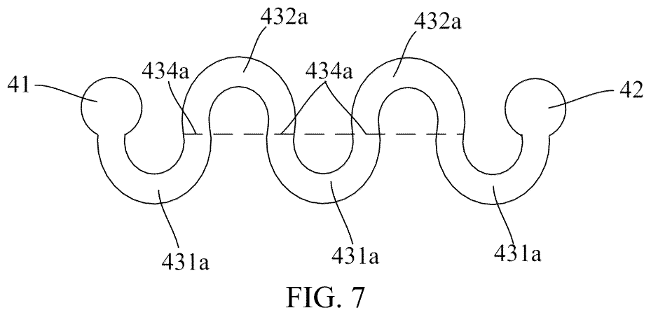

To promote the transmission and vaporization of the high-viscosity liquid substrate, as shown in FIG. 5, the resistance heating trajectory 43 basically cover an extension length of the vaporization surface 320. Specifically:
in the dimensions of the vaporization surface 320, a length d1 is 6.7 mm and a width d3 is 3.2 mm; and
the extension length d2 of the resistance heating trajectory 43 between the first electrode connection portion 41 and the second electrode connection portion 42 is 5.22 mm, that is, in FIG. 7, a distance d2 between straight lines L1 and L2 passing through two ends of the resistance heating trajectory 43 in the width direction of the vaporization surface 320 is 5.22 mm and greater than 75% of d1. A height dimension d4 of the resistance heating trajectory 43 in the width direction is 2.58 mm and greater than 80% of d3, that is, a shortest distance between the resistance heating trajectory 43 in the width direction of the vaporization surface 320 and an upper end/lower end edge of the vaporization surface 320 is less than 0.32 mm; and a distance d5 between each of two ends of the resistance heating trajectory 43 in the length direction and an end side of the vaporization surface 320 is 0.75 mm.

In a usual implementation, the resistance heating trajectory 43 has a resistance value of 0.5 to 2Ω, for example, the resistance value may be 0.7Ω or 1.2Ω.

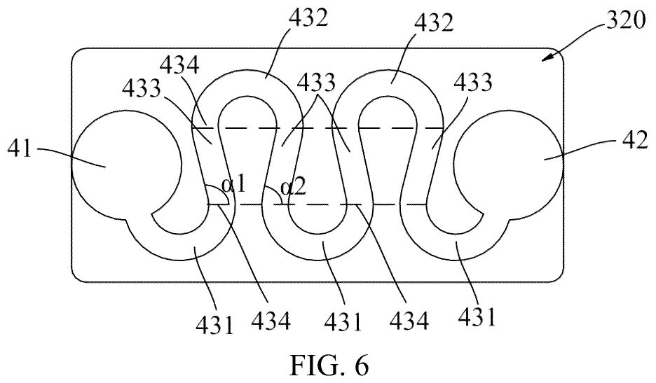

Meanwhile, the first electrode connection portion 41 and the second electrode connection portion 42 are circular and have a diameter of 1.6 mm. The resistance heating trajectory 43 is in a shape of a zigzag strip, and has a trajectory width of about 0.36 mm, so that the resistance heating trajectory 43 has sufficient heating area and ensures the radiation range of a temperature field. For example, in a preferred implementation shown in FIG. 6, the strip area of the resistance heating trajectory 43 is 8.29 mm2, the area of the vaporization surface 320 is 21.41 mm2, and the area of the resistance heating trajectory 43 is greater than 35% of the area of the vaporization surface 320. In a more preferred implementation, the resistance heating trajectory 43 may have larger area by making the resistance heating trajectory 43 have a higher height or a wider trajectory width, for example, the area of the resistance heating trajectory 43 is greater than 50% of the area of the vaporization surface 320.

The extension length and width of the resistance heating trajectory 43 are larger than an existing conventional length and width, so that the temperature field range of the resistance heating trajectory 43 is larger, and the heat radiation area basically can cover the whole vaporization surface 320.

Further, according to preferred implementations shown in FIG. 6 and FIG. 7, the resistance heating trajectory 43 is of a uniquely designed zigzag shape, thereby having a wider and more uniform temperature field. Specifically referring to FIG. 6 or FIG. 7, the resistance heating trajectory 43 includes several alternately arranged first trajectory parts 431/431a, and several second trajectory parts 432/432a, and are formed by sequentially alternately connecting the first trajectory parts and second trajectory parts along the extension length of the resistance heating trajectory 43.

Further, in preferred implementations shown in FIG. 6 and FIG. 7, the first trajectory parts 431/431a located on the outermost side of the length direction of the resistance heating trajectory 43 are directly connected to the first electrode connection portion 41/the second electrode connection portion 42. However, the second trajectory parts 432/432a are not arranged at the outermost side, so as not to be directly connected to the first electrode connection portion 41/the second electrode connection portion 42.

As shown in FIG. 6 and FIG. 7, the first trajectory parts 431/431a and the second trajectory parts 432/432a have opposite or different bending directions in the width direction of the vaporization surface 320. For example, in FIG. 6, the first trajectory parts 431/431a are bent downwards, and the second trajectory parts 432/432a are bent upwards. Meanwhile, according to the figure, the first trajectory parts 431/431a are arranged close to a lower end side of the vaporization surface 320, and the second trajectory parts 432/432a are arranged close to an upper end side of the vaporization surface 320.

As shown in FIG. 6 and FIG. 7, the first trajectory parts 431/431a are of a shape substantially or very close to a semi-circular arc, so that the curvature of each part of the first trajectory parts 431/431a is not 0. Similarly, the second trajectory parts 432/432a are of a shape substantially or very close to a semi-circular arc, and the curvature of each part is not 0.

Further, in preferred implementations of FIG. 6 and FIG. 7, the first trajectory parts 431/431a and the second trajectory parts 432/432a are in a shape of a semi-circular arc with a same curvature radius. That is, the curvatures of the first trajectory parts 431/431a and the second trajectory parts 432/432a are the same. Alternatively, in other variable implementations, the first trajectory parts 431/431a have a curvature or curvature radius different from that of the second trajectory parts 432/432a.

Further, in a preferred implementation shown in FIG. 6, the resistance heating trajectory 43 further includes a third trajectory part 433 extending between the adjacent first trajectory part 431 and second trajectory part 432. The third trajectory part 433 is of a flat shape with a constant curvature of 0, and the first trajectory part 431 and the second trajectory part 432 are connected through the third trajectory part 433 to form electrical conduction. In a preferred implementation, an extension length of the third trajectory part 433 is about 1 mm, and is slightly greater than the radius (0.8 mm) of the first trajectory part 431 and the second trajectory part 432.

Further, according to a preferred implementation shown in FIG. 6, several flat third trajectory parts 433 are arranged obliquely in the vaporization surface 320, that is, have a certain included angle with the width direction of the vaporization surface 320 and are not arranged vertically. Specifically, four third trajectory parts 433 are included in FIG. 6, and the inclination directions of the third trajectory parts are not exactly the same as each other, but are alternately arranged along the extension length direction of the resistance heating trajectory 43. Specifically, according to FIG. 6, an included angle α1 between the third trajectory part 433 closest to the first electrode connection portion 41 on the left side and the length direction of the vaporization surface 320 is an obtuse angle and about 104 degrees; and an included angle α2 between the next third trajectory part 433 and the length direction of the vaporization surface 320 is an acute angle and about 76 degrees. The later third trajectory parts 433 are alternately arranged repeatedly in the above oblique direction.

Further, in FIG. 6 and FIG. 7, due to the variable bending direction or shape of each part of the resistance heating trajectory part 43, several or a plurality of bending direction transition points 434/434a are formed at a position where each part is connected, for example, in FIG. 6, a transition point 434 where two ends of the third trajectory parts 433 and the first trajectory part 431/the second trajectory part 432 are connected; or in FIG. 7, a transition point 434a where the first trajectory part 431a and the second trajectory part 432a are connected. In an implementation shown in FIG. 7, in the resistance heating trajectory 43, the curvature of the part only having limited transition points 434/434a is 0, and the curvatures of other positions are not 0.

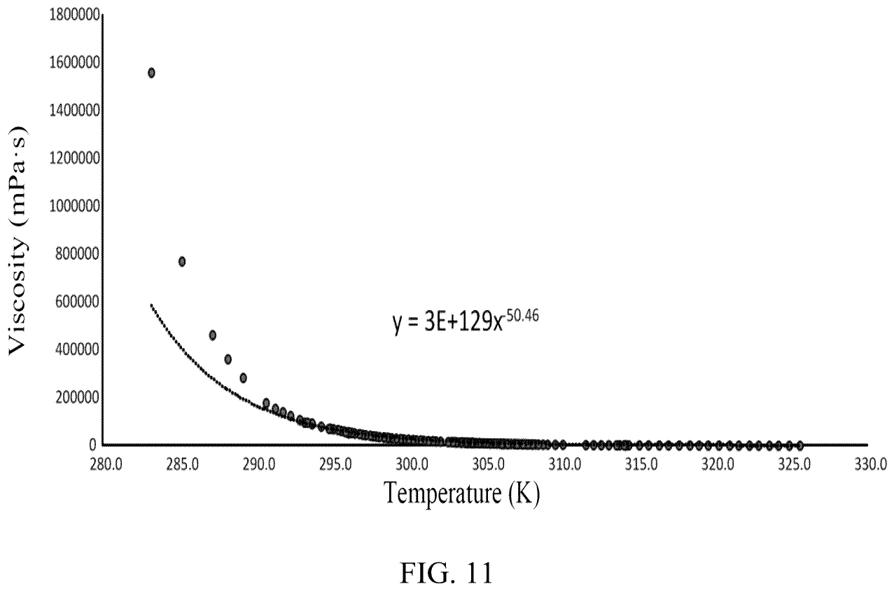

By adoption of the resistance heating trajectory 43 with the bending direction changing periodically, the heat radiation area of the resistance heating trajectory 43 can be uniformly enlarged to other parts of the porous body 30 as much as possible, thereby preheating the high-viscosity liquid substrate to reduce the viscosity. For example, FIG. 11 shows a schematic diagram of a curve of the viscosity of the common high-viscosity liquid substrate with the vegetable glycerin content exceeding 80% changing along with the temperature. The viscosity is about 179000 mPa·s at 290 K, and the viscosity is reduced to 1070 mPa·s when the temperature is increased to 320 K.

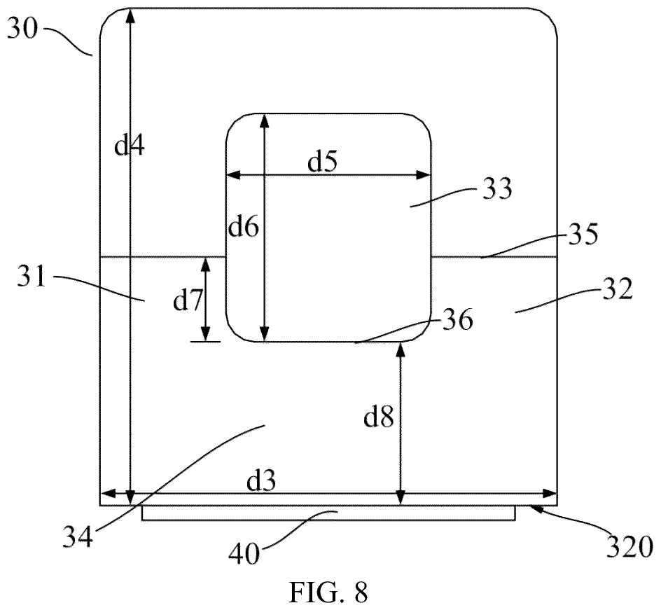

Further, in the above embodiments, the contact area of the porous body 30 and the liquid substrate is increased by the liquid channel 33 so as to improve the efficiency of absorbing and transmitting the liquid substrate. FIG. 8 is a schematic structural diagram of a positive projection of one side of the porous body 30 in the length direction. As shown in FIG. 8:
the porous body 30 has a width d3 of 3.2 mm and a height d4 of 3.65 mm, and the outline area S1 after the whole side omits a filleted corner defect is basically 11.68 mm2. The liquid channel 33 adopts a rectangular cross-section shape of the filleted corner, and has a width d5 of 1.60 mm and a height d6 of 1.94 mm; the section area S2 of the liquid channel 33 is basically 3.1 mm2, and is at least greater than 25% of the outline area S1 of the side of the porous body 30; and it is ensured that the liquid substrate in the liquid channel 33 and the surface of the porous body 30 have sufficient contact area, and the efficiency of the porous body 30 absorbing the high-viscosity liquid substrate is kept. Certainly, in a more preferred implementation, the sectional area S2 of the liquid channel 33 may be increased to be larger, for example, is larger than 50% of the outline area S1 of the side of the porous body 30.

Further, as shown in FIG. 8, the liquid channel 33 at least partially penetrates through a base part 34, for example, in FIG. 8, a depth d7 of the liquid channel 33 extending in the base part 34 is about 0.5 mm; and in the height direction of the porous body 30, a distance d8 between the heating element 40 on the vaporization surface 320 and an inner bottom wall 35 of the liquid channel 33 is less than 1.5 mm, more preferably, may be less than 1 mm. In the implementation in FIG. 8, d8 is 1.2 mm, compared with the height d4 of the porous body 30 being 3.65 mm, d8 is close to and less than ⅓ of the height d4 of the porous body 30. The heat of the vaporization surface 320 can be more rapidly transmitted to the high-viscosity liquid substrate in the liquid channel 33 for preheating, thereby reducing the viscosity.

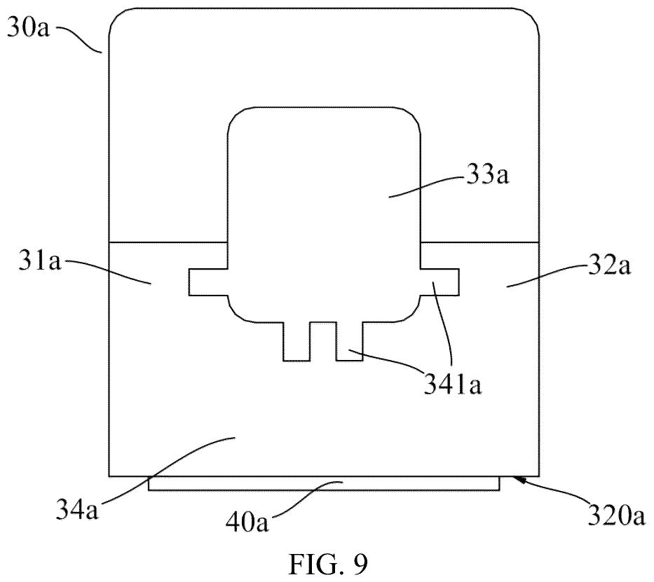

On the basis of enlarging the surface area of the liquid channel 33 at the base part 34, FIG. 9 shows a schematic diagram of a porous body 30a according to another preferred embodiment. A surface, adjacent to or defining the liquid channel 33, of the base part 34a is provided with at least one or more grooves 341a penetrating in the length direction, so that the base part 34a has larger specific surface area, and the efficiency of absorbing and transmitting the high-viscosity liquid substrate is improved. Alternatively, in other variable implementations, the liquid channel 33 may further be designed to have more cross-sectional shapes such as a circle, an ellipse or a polygon.

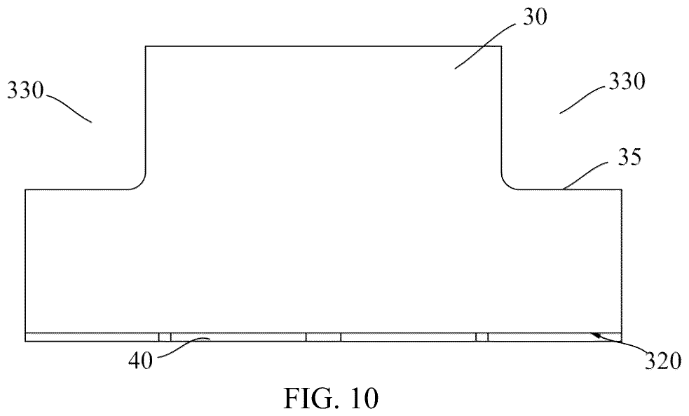

Further, referring to FIG. 10, it is a schematic diagram of a positive projection of one side of a porous body 30 in a thickness direction. An avoidance part 330 opposite to a first liquid guide hole 71/a second liquid guide hole 61/a third liquid guide hole 51 is formed on at least one side (two sides in FIG. 10) of the porous body 30 in the length direction, so that the porous body 30 does not have a part extending between the first liquid guide hole 71/the second liquid guide hole 61/the third liquid guide hole 51 and the liquid channel 33, thereby not shielding a flow path between the first liquid guide hole 71/the second liquid guide hole 61/the third liquid guide hole 51 and the liquid channel 33. A liquid substrate transmitted by the first liquid guide hole 71/the second liquid guide hole 61/the third liquid guide hole 51 directly flows from the avoidance part 330 to the base part 34 and then is stored in the liquid channel 33.

Further, referring to FIG. 8 and FIG. 10, the avoidance parts 330 at two ends of the liquid channel 33 of the porous body 30 are defined by a step surface 35, and the step surface 35 is parallel to the vaporization surface 320. Further, as shown in FIG. 8, the step surface 35 is higher than the inner bottom wall 35, adjacent to the vaporization surface 320, of the liquid channel 330. Specifically, in the dimension, a distance d7 between the inner bottom wall 35 of the liquid channel 330 and the step surface 35 is about 0.5 mm, that is, a distance between the step surface 35 and the vaporization surface 320 is: d7+d8=1.7 mm, compared with the height d4 of the porous body 30 being 3.65 mm, the distance between the step surface 35 and the vaporization surface 320 is close to and less than ½ of the height d4 of the porous body 30.

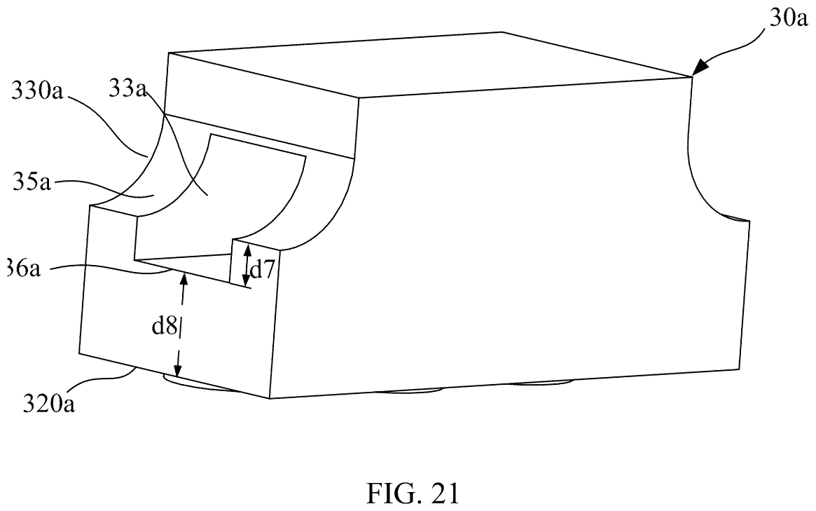

Further, referring to FIG. 21, it is a schematic structural diagram of a porous body 30a according to another variable embodiment. In the variable porous body 30a, an oblique flat or curved arc-shaped step surface 35a defines avoidance parts 330a at two ends of a liquid channel 33a. In the dimension and distance, the step surface 35a is still higher than an inner bottom wall 36a of the liquid channel 33a. Specifically, a distance d8 between the inner bottom wall 36a and the vaporization surface 320a is 1.2 mm, and a shortest distance d7 between the step surface 35a and the inner bottom wall 36a is 0.5 mm.

Further, to promote the transmission and vaporization of the high-viscosity liquid substrate, the porous body 30 is made of a material with a heat conductivity higher than that of the conventional porous ceramic material, so that the porous body 30 has a higher heat conductivity finally; and in an implementation, the porous body 30 has a heat conductivity ranging from 1 to 50 W/(m·K). Specifically, in a preferred implementation, the above porous body 30 is a porous body with a high heat conductivity, prepared by adding an inorganic ceramic component with a high heat conductivity, such as silicon carbide and silicon nitride with the heat conductivity reaching 83.6 W/(m·K) or more, or aluminum nitride and boron nitride with the heat conductivity capable of reaching 220 W/(m·K) or more on a conventional inorganic ceramic raw material such as silicon oxide, zirconium oxide and aluminum oxide.

By adoption of the above porous body 30 with higher heat conductivity, during use, the heat of the resistance heating trajectory 43 can be more rapidly transmitted to other parts in the porous body 30, so that the liquid substrates in other parts can be preheated between the transmission and the vaporization surface 320, the viscosity of the liquid substrate can be reduced through preheating, and the fluidity can be improved.

In an implementation, the heat conductivity of the porous body 30 may be adjusted by changing the weight ratio of the above high-heat-conductivity components such as the silicon carbide and the aluminum nitride. In a more preferred implementation, the porous body 30 has the heat conductivity ranging from 20 to 50 W/(m·K) by adjusting the weight ratio of the silicon carbide and the aluminum nitride. On one hand, the influence on the vaporization efficiency of the liquid substrate on the vaporization surface 320 due to the fact that the heat of the resistance heating trajectory 43 is transmitted to other parts of the porous body 30 by the higher heat conductivity can be avoided; and on the other hand, the fact that the heat of the resistance heating trajectory 43 cannot be effectively transmitted to other parts of the porous body 30 to preheat the high-viscosity liquid substrate when the heat conductivity is lower than the above heat conductivity can be avoided.

Further, to embody the progressiveness of the vaporization assembly with high heat conductivity in the example in FIG. 3/FIG. 4/FIG. 8 according to this application, the vaporization assembly according to the above embodiments is subjected to a performance test by the high-viscosity liquid substrate shown in FIG. 11. The material and parameter of each part of the vaporization assembly is shown in the following table.

| | | | |
|---|---|---|---|
| Resistance Heating | Heat Conductivity | 12.8 | W/m/K |
| Trajectory | Coefficient | | |
| Fe—Cr Alloy | Density | 7200 | kg/m³ |
| Porous Ceramic Body | Heat Conductivity | 44.8 | W/m/K |
| Aluminum Oxide- | Coefficient | | |
| Aluminum Nitride | Density | 900 | kg/m³ |

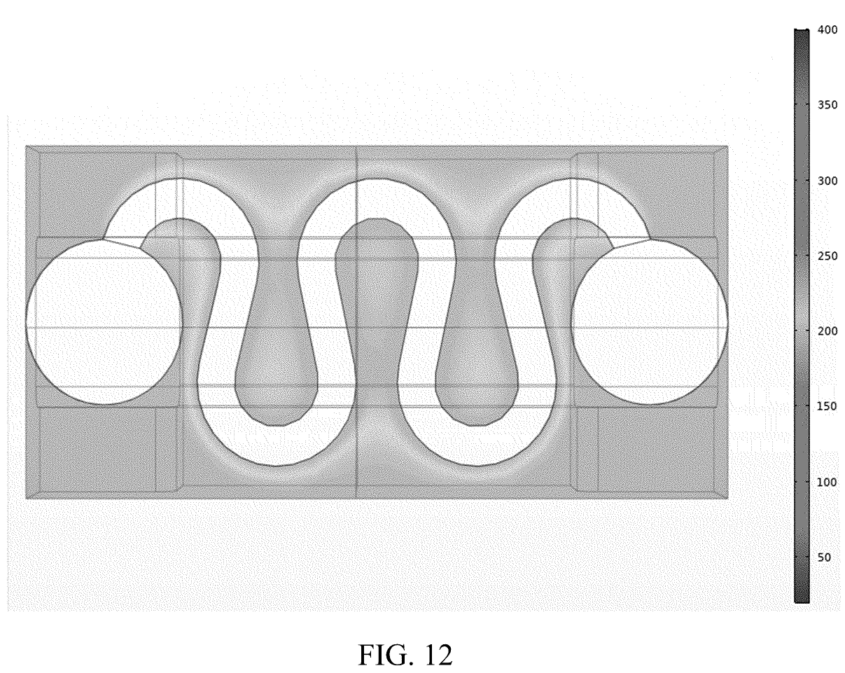

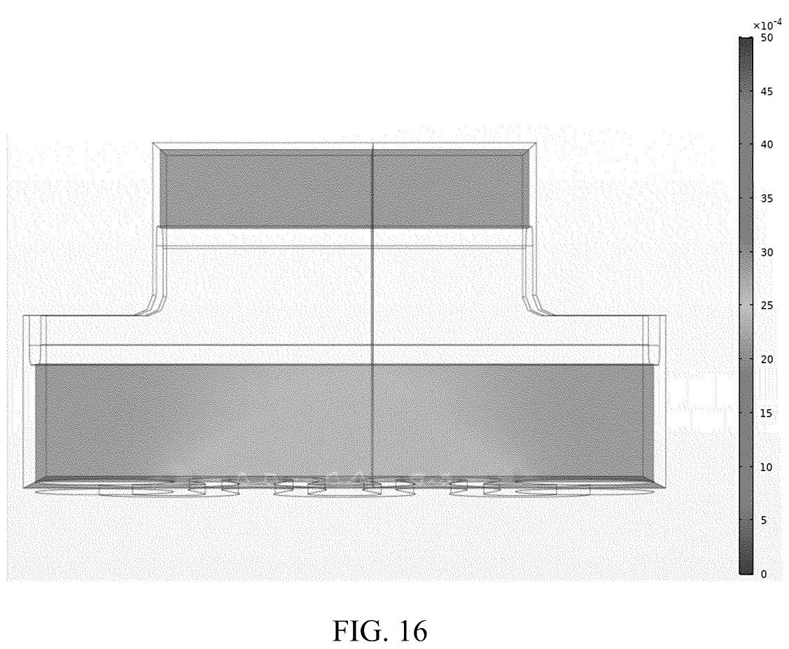

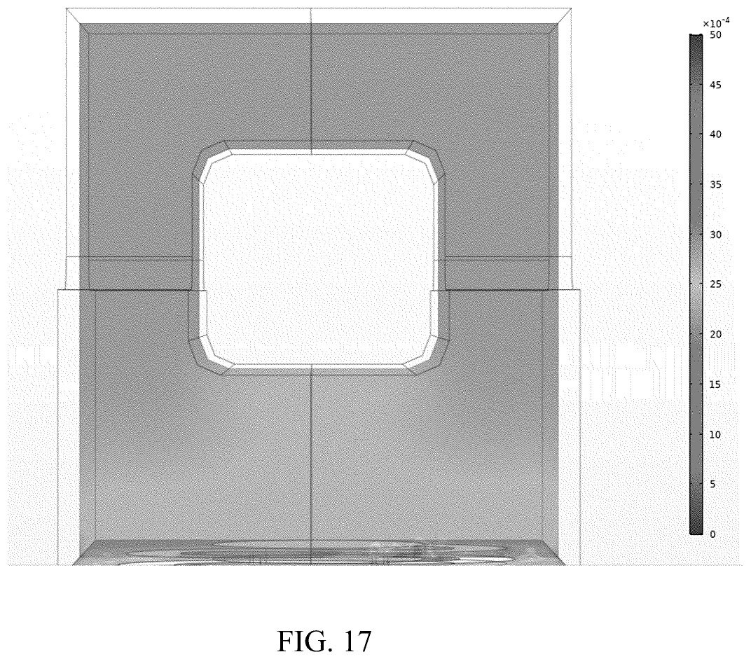

The contents of the test include: a temperature distribution test, and the flow velocity of the liquid substrate in the porous body 30, specifically, the temperature field after a constant power (6.5 W) is loaded on the vaporization assembly according to the embodiment and simulated heating is performed for 3 s, and the flow velocity of the internal liquid substrate. The results are shown in FIG. 12 to FIG. 17.

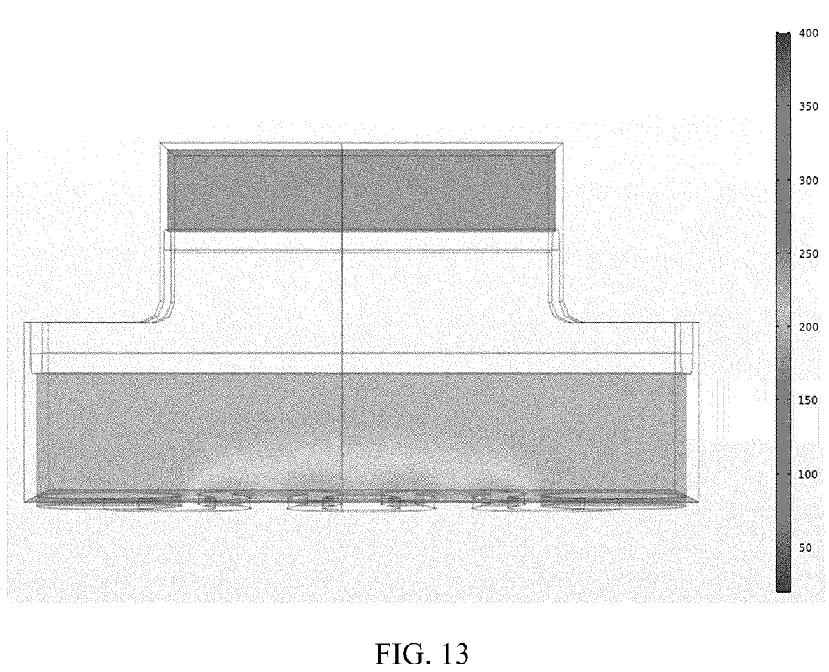

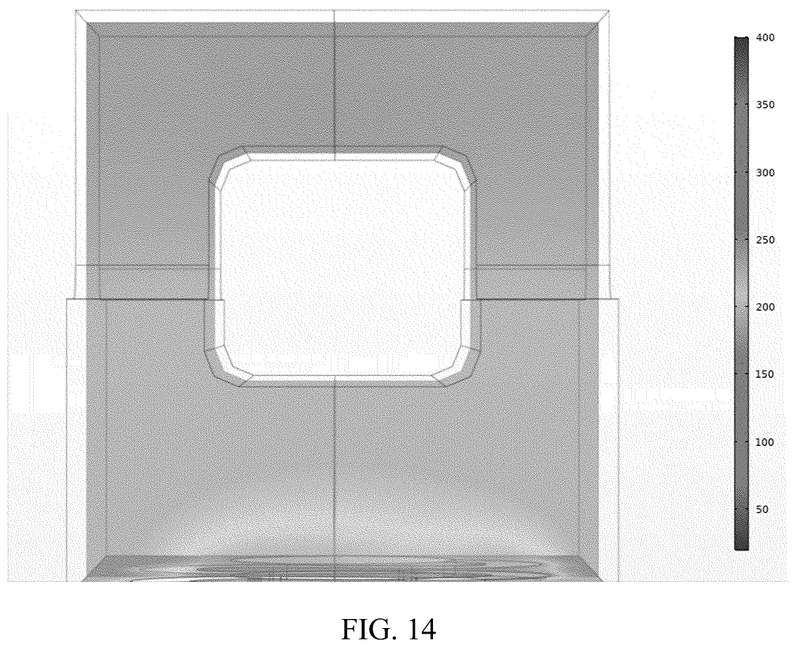

FIG. 12 is a temperature field distribution diagram on a vaporization surface, FIG. 13 is a temperature field distribution diagram of a section in a length direction, and FIG. 14 is a temperature field distribution diagram of a section in a thickness direction. It may be seen from the figure that the highest temperature of the resistance heating trajectory 43 on the vaporization surface 320 is about 300° C., and the interior between the vaporization surface 320 of the vaporization assembly and the liquid channel 33, and the other parts of the vaporization surface 320 can be preheated to about 150° C.

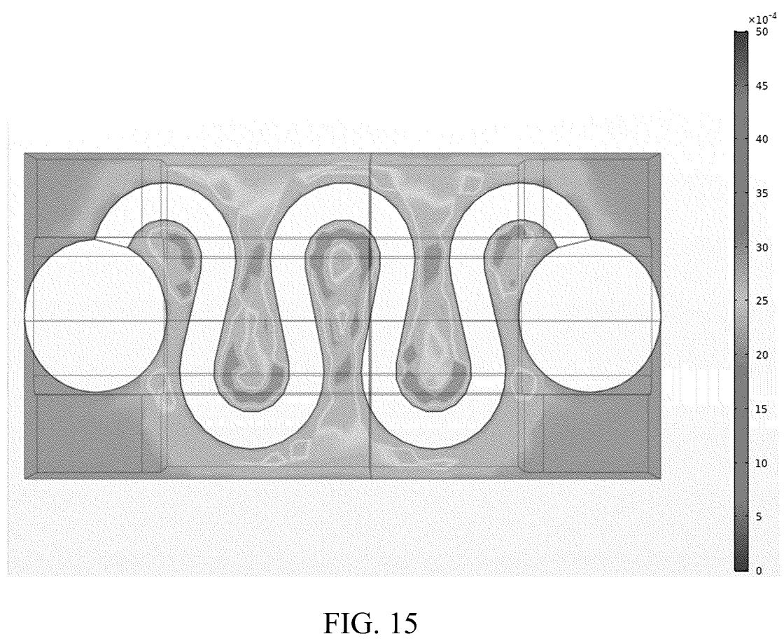

FIG. 15 to FIG. 17 show distribution diagrams of the flow velocity of the liquid substrate of and inside the vaporization surface 320 of the porous body 30 of the vaporization assembly. It may be seen from the figure that the maximum flow velocity of the liquid substrate close to the vaporization surface 320 can basically reach 50×10⁻⁴ m/s, and the flow velocity of the liquid substrate within the extension length range of the resistance heating trajectory 43 in the vaporization surface 320 is basically kept at about 35×10⁻⁴ m/s; and the flow velocity of the liquid substrate of a part between the vaporization surface 320 and the liquid channel 33 is about 15×10⁻⁴ m/s.

Meanwhile, to describe the difference between the temperature and the flow velocity of the liquid substrate in the vaporization assembly implementation of the above embodiments and those of the conventional vaporization assembly of aluminum oxide-zirconium oxide with relatively low heat conductivity, the material and parameter of each part of the conventional vaporization assembly in the comparative implementation is shown in the following table.

| | | | |
|---|---|---|---|
| Resistance Heating | Heat Conductivity | 12.8 | W/m/K |
| Trajectory | Coefficient | | |
| Fe—Cr Alloy | Specific Heat Capacity | 490 | J/kg/° C. |
| | Density | 7200 | kg/m³ |
| Porous Ceramic Body | Heat Conductivity | 1 | W/m/K |
| Aluminum Oxide- | Coefficient | | |
| Zirconium Oxide | Specific Heat Capacity | 430 | J/kg/° C. |
| | Density | 900 | kg/m³ |

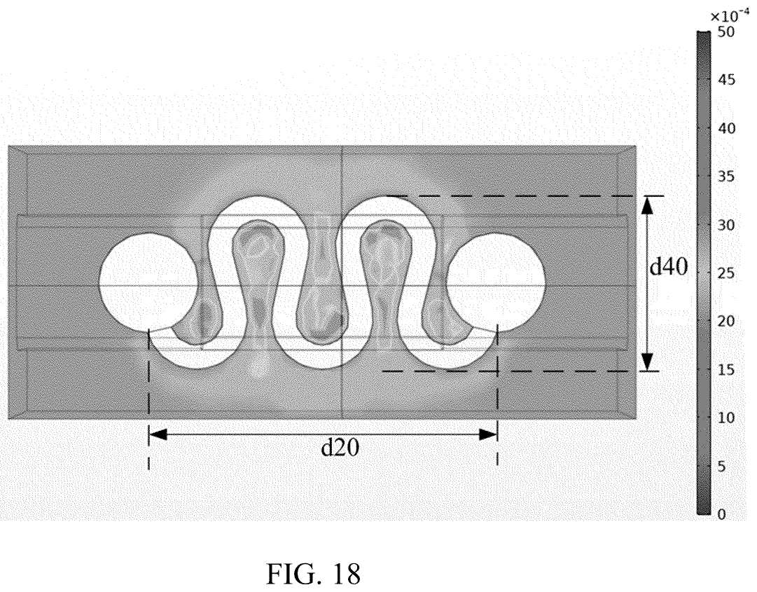

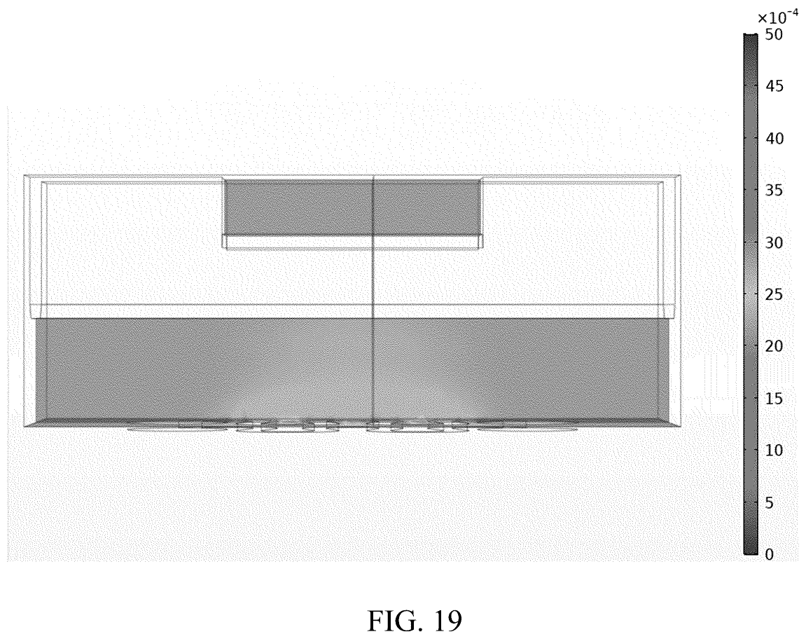

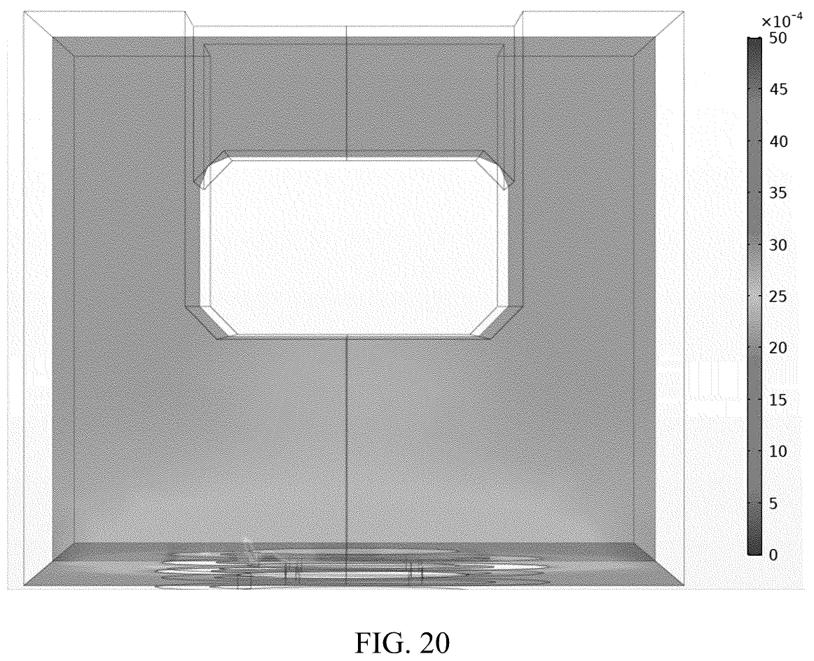

FIG. 18 to FIG. 20 show distribution diagrams of the flow velocity of the same liquid substrate used in the vaporization assembly in one comparative example, and the flow velocity of the liquid substrate of and inside the vaporization surface 320 simulated at the same power and time in the above implementations. It may be seen from the figure that the size ratio of the resistance heating trajectory 43 in the comparative example is reduced; and in the comparative example of FIG. 18, the resistance heating trajectory 43 has the extension length d20 of 3.42 mm and the height d40 of 1.72 mm. Finally, the flow velocity distribution of the liquid substrate within the extension length range of the resistance heating trajectory 43 located in the vaporization surface 320 is quite different, the flow velocity of the liquid substrate of only a few areas adjacent to the resistance heating trajectory 43 can reach 50×10⁻⁴ m/s, and the flow velocity of other areas is basically only 15×10⁻⁴ m/s to 20×10⁻⁴ m/s. The flow velocity of the liquid substrate of the part outside the extension length range of the heating resistance trajectory 43, and flow velocity of the liquid substrate of the part between the vaporization surface 320 and the liquid channel 33 are about 10×10⁻⁴ m/s.

The specification of this application and the accompanying drawings thereof illustrate preferred embodiments of this application. However, this application may be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or modifications according to the foregoing descriptions, and all the improvements and modifications shall fall within the protection scope of the appended claims of this application.

1. A vaporizer, configured to vaporize a liquid substrate to generate an aerosol for inhaling, and comprising:
a liquid storage cavity, configured to store a liquid substrate;
a porous body, being in fluid communication with the liquid storage cavity to absorb the liquid substrate, and having a vaporization surface; and
a resistance heating trajectory, formed on the vaporization surface and configured to heat at least a part of the liquid substrate of the porous body to generate an aerosol;
wherein the vaporization surface is a flat plane, and comprises a length direction and a width direction perpendicular to the length direction; the resistance heating trajectory comprises a first end and a second end, and extends between the first end and the second end in a zigzag way in the length direction of the vaporization surface; and a distance that the first end and the second end span in the vaporization surface in the length direction is greater than 75% of a length dimension of the vaporization surface.

2. The vaporizer according to claim 1, wherein the porous body has a heat conductivity of 1 to 50 W/(m·K).

3. The vaporizer according to claim 2, wherein the porous body comprises a porous ceramic body, the porous ceramic body comprising at least one of silicon carbide, aluminum nitride, boron nitride or silicon nitride.

4. The vaporizer according to claim 1, wherein the resistance heating trajectory at least partially extends in the width direction of the vaporization surface to a position with a shortest distance from an edge of the vaporization surface less than 0.32 mm.

5. The vaporizer according to claim 1, wherein the projection area of the resistance heating trajectory in the vaporization surface is greater than 35% of the area of the vaporization surface.

6. The vaporizer according to claim 1, wherein the resistance heating trajectory comprises a first trajectory part and a second trajectory part which are alternately arranged in the length direction of the vaporization surface, the first trajectory part and/or the second trajectory part being curved and having different bending directions.

7. The vaporizer according to claim 6, wherein the vaporization surface comprises a first side part and a second side part which are opposite to each other in the width direction,
the first trajectory part being close to the first side, and the second trajectory part being close to the second side part.

8. The vaporizer according to claim 7, wherein the first trajectory part and/or the second trajectory part are/is configured to bend outwards in the width direction of the vaporization surface.

9. The vaporizer according to claim 6, wherein the resistance heating trajectory further comprises a third trajectory part extending between the adjacent first trajectory part and second trajectory part; and the third trajectory part is straight.

10. The vaporizer according to claim 9, wherein the third trajectory part is arranged obliquely relative to the width direction of the vaporization surface.

11. The vaporizer according to claim 6, wherein the curvature of any position of the first trajectory part and/or the second trajectory part is not zero.

12. The vaporizer according to claim 6, wherein the resistance heating trajectory is constructed such that the whole trajectory only comprises limited points with the curvature being zero.

13. The vaporizer according to claim 1, wherein the porous body has a liquid channel penetrating through the porous body and is in fluid communication with the liquid storage cavity through the liquid channel to absorb the liquid substrate of the liquid storage cavity.

14. The vaporizer according to claim 13, wherein the liquid channel has an inner bottom wall close to and parallel with the vaporization surface, and a distance between the inner bottom wall and the vaporization surface is less than 1.5 mm.

15. The vaporizer according to claim 13, further comprising:
a liquid guide channel, positioned between the liquid storage cavity and the porous body, and providing a fluid path for the liquid substrate of the liquid storage cavity to flow to the liquid channel,
wherein an end part of the liquid channel in a length direction is defined as an avoidance part by at least one step surface, and the avoidance part is opposite to the liquid guide channel in a longitudinal direction of the vaporizer.

16. The vaporizer according to claim 13, wherein the porous body comprises a first side wall and a second side wall which are arranged oppositely in the width direction of the vaporization surface, and a base part positioned between the first side wall and the second side wall, and the liquid channel is defined jointly by the first side wall, the second side wall and the base part; and
a groove extending in a length direction of the porous body is formed in a surface, adjacent to the liquid channel, of the base part, and is configured to increase the surface area of the base part for absorbing the liquid substrate.

17. A vaporizer, configured to vaporize a liquid substrate to generate an aerosol for inhaling, and comprising:
a liquid storage cavity, configured to store a liquid substrate;
a porous body, being in fluid communication with the liquid storage cavity to absorb the liquid substrate, and having a vaporization surface, wherein the porous body defines a liquid channel that is basically parallel with the vaporization surface and penetrates through the porous body; and
a resistance heating trajectory, formed on the vaporization surface and configured to heat at least a part of the liquid substrate of the porous body to generate an aerosol,
wherein an end part of the liquid channel is defined as an avoidance part by at least one step surface, and a distance between an inner wall of the liquid channel and the vaporization surface is less than a shortest distance between the step surface and the vaporization surface.

18. An electronic vaporization apparatus, comprising a vaporizer configured to vaporize a liquid substrate to generate an aerosol for inhaling, and a power supply assembly supplying power to the vaporizer, wherein the vaporizer comprises the vaporizer according to claim 1.

19. (canceled)
